(19) United States
(12) Patent Application Publication
(10) Pub. No.: US 2026/0014821 A1
(43) Pub. Date: Jan. 15, 2026

(54) Device for Mounting and Demounting a Tyre; a Method of Preparing a Device for Mounting or Demounting a Tyre

(71) Applicant: Hubikes GmbH, Altdorf (DE)

(72) Inventors: Hubert Folwarczny, Altdorf (DE); Alexander Eisele, Engstingen (DE)

(21) Appl. No.: 19/260,651

(22) Filed: Jul. 7, 2025

(30) Foreign Application Priority Data
Jul. 9, 2024 (DE) 102024119434.0

(51) Int. Cl. B60C 25/01

(52) U.S. Cl. CPC B60C 25/01

(57) ABSTRACT

A device (1) for mounting and demounting a tyre and a method of preparing a device for mounting or demounting a tyre are proposed, wherein said device (1) has a main body (2) and a bead breaker element (5), said main body (2) having at least one rail (3), with at least one of said rails (3) having at least one lockable running rail (5) arranged thereon, and said bead breaker element comprising a bead breaker blade (10), a bead breaker arm (9), and a lever element (11), and wherein said device (1) comprises at least one support (8, 17), with at least one of the supports (8, 17) being detachably fastenable to at least one running rail (5), which makes it possible for tyres of different wheel types to be demounted from the wheel rim or mounted onto the wheel rim.

### CROSS REFERENCE TO RELATED APPLICATIONS

This application claims the priority of DE 102024119434.0 filed on 2024 Jul. 9; this application is incorporated by reference herein in its entirety.

### BACKGROUND

The invention is based on a device for mounting and demounting a tyre according to the preamble of claim 1 and on a method of preparing a device for mounting or demounting a tyre according to the preamble of claim 13.

Such devices for mounting and demounting a tyre have been state of the art for a long time. Changing the tyre on a rim is a cost-effective alternative to the more expensive replacement of the entire wheel. Apart from a great variety of expensive, automated systems, there is also a great number of manually operated systems. The utility model DE 20 2018 100 207 U1, for example, discloses a foldable mobile device for mounting and demounting tyres onto or from a wheel rim, said device comprising a frame having four arms for supporting the tyre and a bead breaker element. The arms can be folded away. The support elements are in the form of running rails and are slid onto the base frame. A comparable solution in which, in addition, the bead breaker arm has a joint formed thereon may be found in DE 20 2021 104 074 U1. Another example is provided by Korean patent application KR 20100010762 A, in which a main body that is connected to the floor has a plate including a plurality of displaceable clamps for fixedly holding the rim in position and a bead breaker element for removing the tyre from the rim, and in which the mounting and demounting of the tyre can be carried out on different working sites. EP 2 599 649 A1 discloses a system for supporting a tyre and fixedly holding it in position as it is mounted onto, and demounted from, a wheel rim, said system including rotatably extendable arms having supports arranged thereon which grip the edge of the rim from below and press against its outer edge in order to fixedly hold the rim in position.

The aforementioned systems and devices have the disadvantage that they are each designed for being used with a given type of wheel and that for different wheel types, such as those of scooters, touring bikes, motocross bikes, and passenger cars, different types of devices and systems need to be employed.

### SUMMARY

A device (1) for mounting and demounting a tyre and a method of preparing a device for mounting or demounting a tyre are proposed, wherein said device (1) has a main body (2) and a bead breaker element (5), said main body (2) having at least one rail (3), with at least one of said rails (3) having at least one lockable running rail (5) arranged thereon, and said bead breaker element comprising a bead breaker blade (10), a bead breaker arm (9), and a lever element (11), and wherein said device (1) comprises at least one support (8, 17), with at least one of the supports (8, 17) being detachably fastenable to at least one running rail (5), which makes it possible for tyres of different wheel types to be demounted from the wheel rim or mounted onto the wheel rim.

### DETAILED DESCRIPTION

It is therefore an object of the invention to provide a device for mounting and demounting a tyre that overcomes the disadvantages of the state of the art and to provide a method of preparing a device for mounting and demounting a tyre which overcomes the disadvantages of the state of the art.

The inventive device for mounting and demounting a tyre having the features of claim 1 and the inventive method of preparing a device for mounting or demounting a tyre having the features of claim 13 have the advantage over prior art that said device for mounting and demounting a tyre onto, or from, a rim of a wheel has a main body and a bead breaker element, said main body having at least one rail, with at least one of said rails having at least one lockable running rail arranged thereon, and said bead breaker element comprising a bead breaker blade, a bead breaker arm, and a lever element, and that said device comprises at least two supports for at least two different types of wheel, respectively, which may be a wheel for a scooter, a touring bike, a motocross bike, a passenger car or the like, with at least one of said supports being detachably fastenable to at least one running rail, which makes it possible for the device to be employed in a simple manner for different wheel types by using different supports. It would be conceivable that at least one rail has markings thereon which may, for example, comprise position information for placing the running rails that are specific for different tyre types and/or diameters. The running rails may be locked in position with the aid of different fastening means such as clamping levers, snap-in connections and screws, as well as bolts or split pins that are passed through the respective running rail and corresponding rail. Preferably, the main body and/or the rails are made of a metal, an alloy or a composite material, thus minimising the wear and tear caused by the forces applied during the mounting process. Obviously, the use of other materials would also be conceivable. The supports are preferably made of a plastic material, a ceramic material, a composite material, a metal, or a metal alloy and, in a particularly preferred embodiment, are provided with a rubber coating and/or consist of a material which is softer than an ordinary wheel rim. This has the advantage that the rim that has to be worked on will not be scratched by the device, in particular by the supports.

According to an advantageous configuration of the inventive device, the main body has a centring bar arranged thereon. This bar may be integrally mounted to the main body or may be detachably fastened thereto. It would be conceivable that the centring bar can be screwed into a hole formed in the main body or that the centring bar is connected to the main body via a snap-in connection or by means of one or several split pins. It is further conceivable that the centring bar has at least one retaining ring which surrounds the centring bar at least partially and may serve as an additional support for the rim since the centring bar preferably has a diameter which is specific for certain axle holes of a rim. In this respect, it would be conceivable to provide different centring bars that are each designed for a given rim type, respectively. It would further be conceivable that the centring bar is not in the form of a straight rod but has a pointed or tapered shape, so that its diameter varies along its longitudinal axis, and that the working diameter for the axle holes, which may be specific for different wheel types, can be adjusted by varying the screw depth to which the centring bar is screwed into the main body.

According to an additional advantageous configuration of the inventive device, the main body has at least one leg arranged thereon. Preferably, the main body is in the form of a tripod.

According to a pertinent advantageous configuration of the inventive device, at least one of the legs has a rubber foot and/or a mandrel. It would be conceivable that these can alternatively be folded down, depending on the specific type of ground surface the device is to be placed on, such that the device will always ensure the best possible grip. In this respect, it would be conceivable that the mandrel and the rubber foot are arranged on a rocker that is connected to a respective leg, such that depending on the type of ground on which the leg is to be placed either the rubber foot or the mandrel will be folded down, with the additionally conceivable option of having a neutral position in which both the mandrel and the rubber foot would be positioned approximately orthogonally with respect to the leg, such that neither the mandrel nor the rubber foot would contact the ground.

According to an additional advantageous configuration of the invention, at least one of the running rails has a groove, with at least one support being insertable into at least one of the grooves by means of a tongue-and-groove connection. In this case, part of the support forms the tongue, whereas the groove is arranged on the running rail. It would also be conceivable that the groove has no straight and/or continuous groove walls but has slightly bent groove walls or groove walls provided with recesses to be engaged with by a portion of a support. In these cases the connection between the support and the groove would provide better fit accuracy and could not be easily slid out of position, which would prevent the support from being inserted in a wrong or inexact position.

According to a pertinent advantageous configuration of the inventive device, at least one of the supports can be fastened to at least one of the grooves. It would be conceivable to have a clamping connection or a snap-in connection, or to use a split pin or a bolt that is passed through lateral openings formed in the groove walls and in the portion of the support that engages with the groove.

According to an additional advantageous configuration of the inventive device, at least one of the supports has a bent head. This head is preferably adapted, or adaptable, to the inner contour of a tyre or a rim ring.

According to an additional advantageous configuration of the inventive device, the main body and/or the legs are foldable. In this respect, it would either be conceivable that the legs are folded against the main body or else that the legs are folded up by means of at least one joint. It would equally be conceivable that the legs are slid into each other, comparable to a telescopic rod. It would be conceivable for the main body to be equally foldable via at least one joint, which may be, for example, a hinge.

According to an additional advantageous configuration of the inventive device, the bead breaker arm is extendable and/or is insertable into the groove of a running rail via a tongue-and-groove connection, which makes it possible to use bead breaker arms of varying lengths.

According to an additional advantageous configuration of the inventive device, the lever element is directly connected to the bead breaker arm or is connected thereto via a joint. The connection may be solid or detachable. It would, for example, be conceivable that the lever element is snap-inserted into an opening formed in the bead breaker arm. It would also be conceivable that the connection is established via at least one joint permitting the lever arm to be moved upwards and/or sideways, which would have the advantage that the position assumed by the user need not be changed during the bead breaking process.

According to an additional advantageous configuration of the inventive device, the main body and/or the centring bar have/has an anti-rotation device arranged thereon which prevents the wheel rim from rotating. It would be conceivable to provide a stopper or a brake pressing against the rim ring or against the tyre, or a rod that is passed through the rim.

The inventive method of preparing a device for mounting or demounting a tyre, said device being a device as claimed in any one of claims 1 to 12 and said tyre being, or being supposed to be, arranged on a wheel rim, has the advantage over prior art that a bead breaker element is fastened to the main body and a suitably dimensioned centring bar is fastened to the main body such that the wheel rim may be positively slid onto the centring bar, at least one flat support is fastened to a running rail and at least one running rail is positioned in such a manner that, as the rim is slid onto the centring bar, the rim or the tyre may be placed onto the at least one support, or at least one support having a bent head is fastened to the main body and at least one running rail is positioned in such a manner that the rim may be placed onto said at least one support, with the tyre being preferably centred above the main body and the bent head of the at least one support holding the tyre fixedly in its centred position, which makes it possible for the device to be easily converted between different applications for different wheels.

Further advantages and advantageous configurations of the invention may be found in the following description, in the claims and in the drawings.

### BRIEF DESCRIPTION OF THE DRAWINGS

Preferred embodiment examples of the object of the invention are represented in the drawings and will be described hereunder in greater detail. In the drawings:

FIG. 1 is a schematic representation of an embodiment example of an inventive device,

FIG. 2 is a schematic representation of an embodiment example of a running rail for an inventive device,

FIG. 3 is a schematic representation of an embodiment example of a support for an inventive device,

FIG. 4 is a schematic representation of an embodiment example of a bent support for an inventive device,

FIG. 5 is a schematic representation of an embodiment example of a support for an inventive device which has been inserted into a running rail,

FIG. 6 is a schematic representation of an embodiment example of a combination of a bent support and a bead breaker arm and bead breaker blade for an inventive device,

FIG. 7 is a schematic representation of another embodiment example of an inventive device, equipped for being used with motocross wheels,

FIG. 8 is a schematic representation of another embodiment example of an inventive device, equipped for being used with scooter wheels, and

FIG. 9 is a schematic representation of a bead breaker arm for an inventive device including an additional joint.

### DETAILED DESCRIPTION OF THE PREFERRED EMBODIMENTS

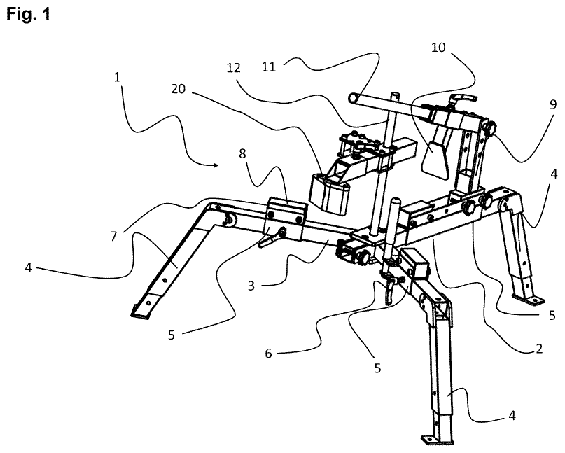

FIG. 1 shows a schematic representation of an embodiment example of an inventive device 1. The device 1 comprises a main body 2 that has rails 3 ending in legs 4. Running rails 5 are movably arranged along the rails 3 and are held in position on the rail 3 via clamping elements 6. The running rails 5 have each a groove 7 into which the supports 8 are inserted. A bead breaker arm 9 is equally fastened to a running rail 5. The bead breaker arm 9 has a bead breaker blade 10 arranged thereon which can be engaged between the tyre and the wheel rim in order to lever the tyre off the rim. On the upper end of the bead breaker arm 9 the bead breaker blade 10 has a depression provided thereon for accommodating a lever element 11 that engages therewith and serves for exerting pressure on the bead breaker blade 10. In addition, the main body 2 has a centring bar 12 screwed thereon which can accommodate the hub of the wheel rim. Furthermore, the centring bar 12 has a stopper 20 disposed thereon which can press against the rim in order to hold it in position.

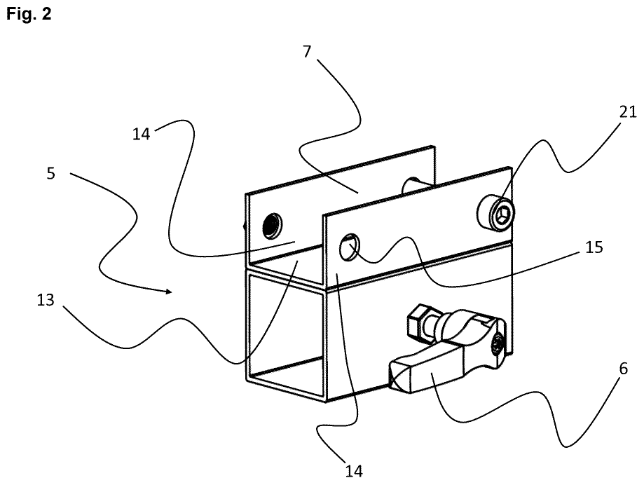

FIG. 2 shows a schematic representation of an embodiment example of a running rail 5 for an inventive device 1. The running rail 5, which can be fastened on a rail 3 by means of a clamping element 6, has a groove 7 that is formed on its top surface and comprises a groove bottom 13 and two groove walls 14. The groove walls 14 have holes 15 provided therein which serve for fastening the support 8 within the groove 7 with the aid of a bolt 21, for example.

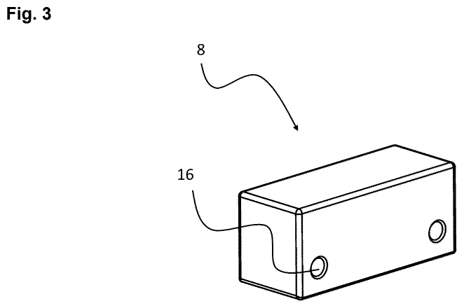

FIG. 3 shows a schematic representation of an embodiment example of a support 8 for an inventive device 1. Like the groove walls 14, the support 8 is equally provided with holes 16 through which a bolt 21 or, alternatively, a split pin may be passed in order to fasten the support 8 to the groove 7.

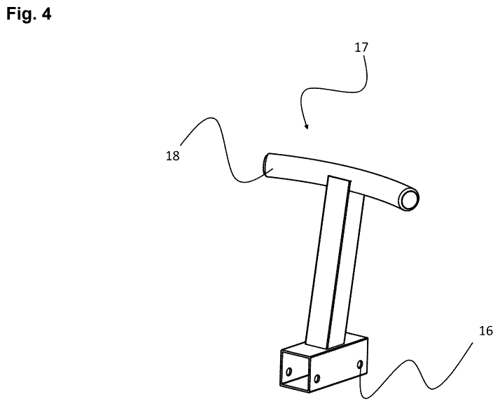

FIG. 4 shows a schematic representation of an embodiment example of a bent support 17 for an inventive device 1. The bent support 17 comprises a bent head 18 and is also provided with holes 16, allowing it to be fastened within a groove 7 of a running rail 5. The bent head 18 is pressed against the inner contour of the rim ring in order to hold the rim in a centred position.

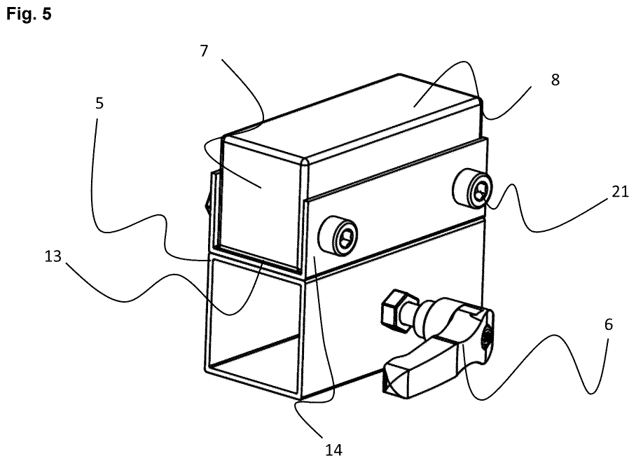

FIG. 5 shows a schematic representation of an embodiment example of a support 8 according to FIG. 3 for an inventive device 1 which is inserted into a running rail 5 according to FIG. 2.

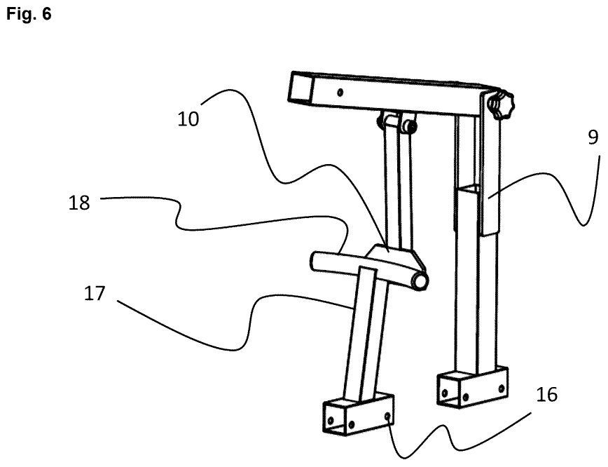

FIG. 6 shows a schematic representation of an embodiment example of a combination of a bent support 17 and a bead breaker arm 9 including a bead breaker blade 10, to be used in an inventive device 1.

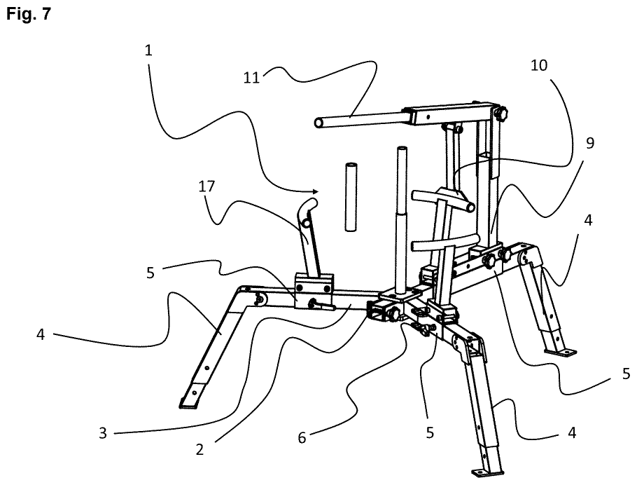

FIG. 7 shows a schematic representation of another embodiment example of an inventive device 1, equipped for being used with motocross wheels.

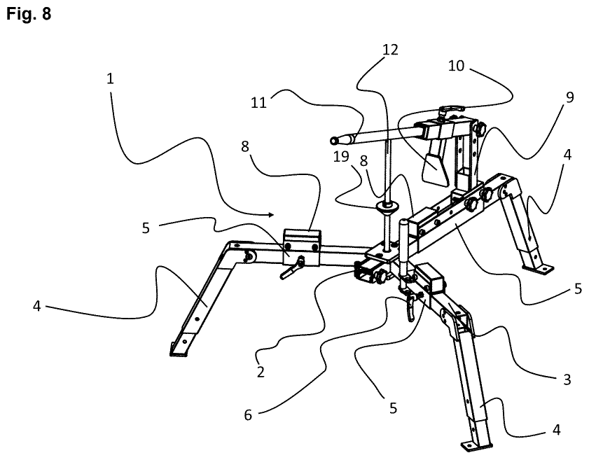

FIG. 8 shows a schematic representation of another embodiment example of an inventive device 1, equipped for being used with scooter wheels. The illustrated embodiment of the inventive device 1 has a smaller centring bar 12 and a taper 19, allowing an improved orientation of the rim.

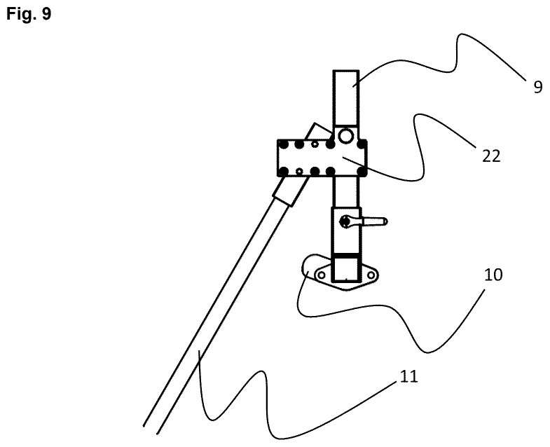

FIG. 9 shows a schematic representation of a bead breaker arm 9 for an inventive device 1 including an additional joint 22. The additional joint 22 is arranged on the bead breaker arm in such a manner that a user can utilise the lever element 11 without having to change his or her position since it is sufficient to move the position of the joint 22 in order to be able to exert a maximum force on the bead breaker blade 10.

All of the characteristics represented herein, as considered either in themselves or in any combination with each other, may be deemed essential to the invention.

### LIST OF REFERENCE NUMERALS

1 device
2 main body
3 rail
4 leg
5 running rail
6 clamping element
7 groove
8 support
9 bead breaker arm
10 bead breaker blade
11 lever element
12 centring bar
13 groove bottom
14 groove wall
15 hole
16 hole
17 bent support
18 bent head
19 taper
20 stopper
21 bolt
22 joint

1. A device (1) for mounting and demounting a tyre onto, or from, a rim of a wheel,
including a main body (2), said main body (2) having at least one rail (3), with at least one of said rails (3) having at least one lockable running rail (5) arranged thereon,
including a bead breaker element (5), said bead breaker element comprising a bead breaker blade (10), a bead breaker arm (9), and a lever element (11),
characterised in that
said device (1) comprises at least two supports (8, 17), for at least two different types of wheel, respectively, which may be a wheel for a scooter, a touring bike, a motocross bike, a passenger car or the like, with at least one of the supports (8, 17) being detachably fastenable to at least one running rail (5).

2. The device (1) as claimed in claim 1,
characterised in that
the main body (2) has a centring bar (12) arranged thereon.

3. The device (1) as claimed in claim 1,
characterised in that
the main body (2) has at least one leg (4) arranged thereon.

4. The device (1) as claimed in claim 3,
characterised in that
at least one of said legs (4) has an enlarged support surface formed on its end facing away from the main body.

5. The device (1) as claimed in claim 3,
characterised in that
at least one of the legs (4) has a rubber foot and/or a mandrel.

6. The device (1) as claimed in claim 1,
characterised in that
at least one of the running rails (5) has a groove (7), with at least one support (8, 17) being insertable into at least one of the grooves (7) by means of a tongue-and-groove connection.

7. The device (1) as claimed in claim 6,
characterised in that
at least one of the supports (8, 17) can be fastened to at least one of the grooves (7).

8. The device (1) as claimed in claim 1,
characterised in that
at least one of the supports (17) has a bent head (18).

9. The device (1) as claimed in claim 1,
characterised in that
the main body (2) and/or the legs (4) are foldable.

10. The device (1) as claimed in claim 1,
characterised in that
the bead breaker arm (9) is extensible and/or may be inserted into the groove (7) of a running rail (5) via a tongue-and-groove connection.

11. The device (1) as claimed in claim 1,
characterised in that
the lever element (11) is directly connected to the bead breaker arm (9) or is connected thereto via a joint.

12. The device (1) as claimed in claim 1,
characterised in that
the main body (2) and/or the centring bar (12) have/has at least one anti-rotation device arranged thereon.

13. A method of preparing a device for mounting or demounting a tyre, said device being a device (1) as claimed in claim 1 and said tyre being, or being supposed to be, arranged on a wheel rim,
characterised in that
a bead breaker element is fastened to the main body (2)
and
a suitably dimensioned centring bar (12) is fastened to the main body (2) such that the wheel rim may be positively slid onto the centring bar (12), at least one support (8) is fastened to a running rail (5), and at least one running rail (5) is positioned in such a manner that, as the rim is slid onto the centring bar (12), the rim or the tyre may be placed onto the at least one support (8),
or
at least one support (17) having a bent head (18) is fastened to the main body (2) and at least one running rail (5) is positioned in such a manner that the rim may be placed onto said at least one support (17), with the tyre being preferably centred above the main body (2) and the bent head (18) of the at least one support (17) holding the tyre fixedly in its centred position.
